(19) United States
(12) Patent Application Publication
(10) Pub. No.: US 2018/0113584 A1
(43) Pub. Date: Apr. 26, 2018

(54) PROCESSING ACTIONS FOR APPARATUSES IN SPECIFIED GEOLOCATION

(71) Applicant: SAP SE, Walldorf (DE)

(72) Inventor: Janos Varadi, Ludwignshafen (DE)

(21) Appl. No.: 15/332,382

(22) Filed: Oct. 24, 2016

(51) Int. Cl. G06F 3/0484; H04L 29/08; G06F 3/0482; G06F 17/30; G01C 21/34; G01C 21/36

(52) U.S. Cl. CPC G06F 3/0484; H04L 67/18; G01C 21/3676; G06F 17/30241; G01C 21/343; G06F 3/0482

(57) ABSTRACT

Systems and methods are provided for receiving a request to perform an action on a selection of apparatuses in a map of a specified geolocation, the request comprising the requested action and the selection of the apparatuses in the map of the specified geolocation, performing operations according to the requested action, and providing, to a computing device, results of the operations performed according to the requested action, wherein the results are displayed on a graphical user interface of the computing device.

### BACKGROUND

The Internet of Things (IoT) refers to a system of interrelated objects (e.g., apparatuses such as computing devices, mechanical and digital machines, etc.) and the ability to communicate between these objects and with other devices and systems. The IoT extends internet connectivity beyond traditional devices like desktop and laptop computers and mobile devices, to a diverse range of objects that utilize embedded technology.

The IoT may comprise billions of objects. Searching for, reviewing, and managing objects in the IoT can entail various challenges.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some example embodiments.

FIGS. 2-4 illustrate example graphical user interfaces, according to some example embodiments.

FIG. 5 is a flowchart illustrating aspects of a method, according to some example embodiments.

FIGS. 6-10 illustrate example graphical user interfaces, according to some example embodiments.

FIG. 11 is a flowchart illustrating aspects of a method, according to some example embodiments.

FIGS. 12-18 illustrate example graphical user interfaces, according to some example embodiments.

FIG. 19 is a block diagram illustrating an example of a software architecture that may be installed on a machine, according to some example embodiments.

FIG. 20 illustrates a diagrammatic representation of a machine, in the form of a computer system, within which a set of instructions may be executed for causing the machine to perform any one or more of the methodologies discussed herein, according to an example embodiment.

### DETAILED DESCRIPTION

Systems and methods described herein relate to managing objects in the IoT. As mentioned above, these objects may comprise apparatuses such as computing devices, mechanical and digital machines, and so forth. These objects may be embedded with electronics, software, sensors, actuators, and network connectivity to enable collection and exchange of data between objects and other devices and systems. Data processing systems described herein may analyze and process information associated with sensor networks where the sensor networks provide information about the objects and make predictions about the states of the objects or provide information regarding how to optimize the objects. Systems and processes described herein further provide for sensing and/or controlling objects remotely.

Example embodiments allow a developer to develop applications to allow a user to search for objects, review objects, collect various objects, and process actions related to the objects. For example, a developer may develop an application related to maintenance for various machines. A user may use such an application to search for machines in a particular geolocation. The user may review the status of various machines in the particular geolocation, select one or more machines, and request an action to be performed on the selection of the one or more machines. For example, the user may request a comparison be made of two or more machines, request a work order related to maintenance of the machines, turn the power on and off for one or more of the machines, and so forth.

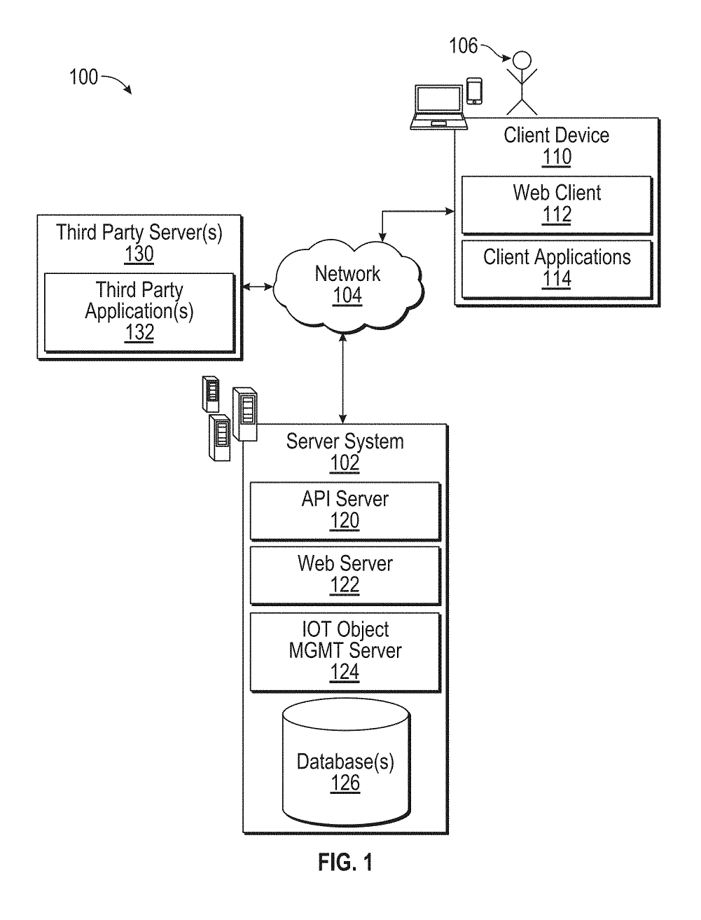

FIG. 1 is a block diagram illustrating a networked system 100, according to some example embodiments, configured to manage objects in the IoT. The system 100 may include one or more client devices such as client device 110. The client device 110 may comprise, but is not limited to, a mobile phone, desktop computer, laptop, portable digital assistants (PDA), smart phone, tablet ultra book, netbook, laptop, multi-processor system, microprocessor-based or programmable consumer electronic, game console, set-top box, computer in a vehicle, or any other communication device that a user may utilize to access the networked system 100. In some embodiments, the client device 110 may comprise a display module (not shown) to display information (e.g., in the form of user interfaces). in further embodiments, the client device 110 may comprise one or more of touch screens, accelerometers, gyroscopes, cameras, microphones, global positioning system (GPS) devices, and so forth. The client device 110 may be a device of a user that is used to search and display objects, review objects, collect various objects, and process actions related to objects.

One or more users 106 may be a person, a machine, or other means of interacting with the client device 110. In example embodiments, the user 106 may not be part of the system 100, but may interact with the system 100 via the client device 110 or other means. For instance, the user 106 may provide input (e.g., touch screen input or alphanumeric input) to the client device 110 and the input may be communicated to other entities in the system 100 (e.g., third party servers 130, server system 102, etc.) via the network 104. In this instance, the other entities in the system 100, in response to receiving the input from the user 106, may communicate information to the client device 110 via the network 104 to be presented to the user 106. In this way, the user 106 may interact with the various entities in the system 100 using the client device 110.

The system 100 may further include a network 104. One or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The client device 110 may access the various data and applications provided by other entities in the system 100 via web client 112 (e.g., a browser, such as the Internet Explorer® browser developed by Microsoft® Corporation of Redmond, Wash. State) or one or more client applications 114. The client device 110 may include one or more client applications 114 (also referred to as “apps”) such as, but not limited to, a web browser, messaging application, electronic mail (email) application, an e-commerce site application, a mapping or location application, an application for managing objects in the IoT, and the like. In some embodiments, one or more client applications 114 may be included in a given one of the client device 110, and configured to locally provide the user interface and at least some of the functionalities, with the client application 114 configured to communicate with other entities in the system 100 (e.g., third party servers 130, server system 102, etc.), on an as needed basis, for data and/or processing capabilities not locally available (e.g., access location information, access object location and status, to authenticate a user 106, to verify a method of payment, etc.). Conversely, one or more applications 114 may not be included in the client device 110, and then the client device 110 may use its web browser to access the one or more applications hosted on other entities in the system 100 (e.g., third party servers 130, server system 102, etc.).

A server system 102 may provide server-side functionality via the network 104 (e.g., the Internet or wide area network (WAN)) to one or more third party servers 130 and/or one or more client devices 110. The server system 102 may include an application program interface (APT) server 120, a web server 122, and an IoT object management server 124, that may be communicatively coupled with one or more databases 126.

The one or more databases 126 may be storage devices that store data related to objects such as names of the objects, unique identifiers for the objects, model numbers, status of the objects, images related to the objects, descriptions of the objects, manufacturer information f©r the objects, release information (e.g., date, version, etc.), expiration dates, service dates, geolocation, and so forth. The one or more databases 126 may further store information related to third party servers 130, third party applications 132, client devices 110, client applications 114, users 106, and so forth. The one or more databases 126 may be regularly updated with status information or updates from various objects in the IoT. For example, an object may detect updated status information related to any defects or alarms for the object (e.g., a street light has burned out, a machine is overheating, a device is not functioning properly), status of any maintenance or changes performed to or by the object, whether the object is powered on or off, whether the object is online or offline, and so forth. The object may send status information to a back-end system (e.g., third party server(s) 130, server system 102, etc.), or a back-end system may pull the information from the object (e.g., request and receive data from the object). The back-end system may store the information in one or more databases 126 or send the information to be stored in the one or more databases 126. The one or more databases 126 may be cloud-based storage.

The server system 102 may be a cloud computing environment according to some example embodiments. The server system 102, and any servers associated with the server system 102, may be associated with a cloud-based application, in one example embodiment.

The IoT object management server 124 may provide back-end support for third-party applications 132 and client applications 114, which may include cloud-based applications. The IoT object management server 124 may process requests for geolocation and status information of objects, retrieve various data related to objects, provide data related to objects to applications (e.g., third-party applications 132, client applications 114, etc.), receive a selection of objects and instructions related to processing the objects, and perform operations according to the instructions for the objects.

The system 100 may further include one or more third party servers 130. The one or more third party servers 130 may include one or more third party application(s) 132. The one or more third party application(s) 132, executing on third party server(s) 130, may interact with the server system 102 via API server 120 via a programmatic interface provided by the API server 120. For example, one or more the third party applications 132 may request and utilize information from the server system 102 via the API server 120 to support one or more features or functions on a website hosted by the third party or an application hosted by the third party. The third party website or application 132, for example, may provide to a user mapping, location, and status information associated with objects in the IoT that are supported by relevant functionality and data in the server system 102.

In one example embodiment, a software development kit (SDK) may be provided to allow a developer to develop applications to allow a user to search for objects, review objects, collect various objects, and process actions related to the objects. For example, the SDK may include a library that a developer may include in an application to achieve such functionality without having to independently develop and write the software code for the functionality.

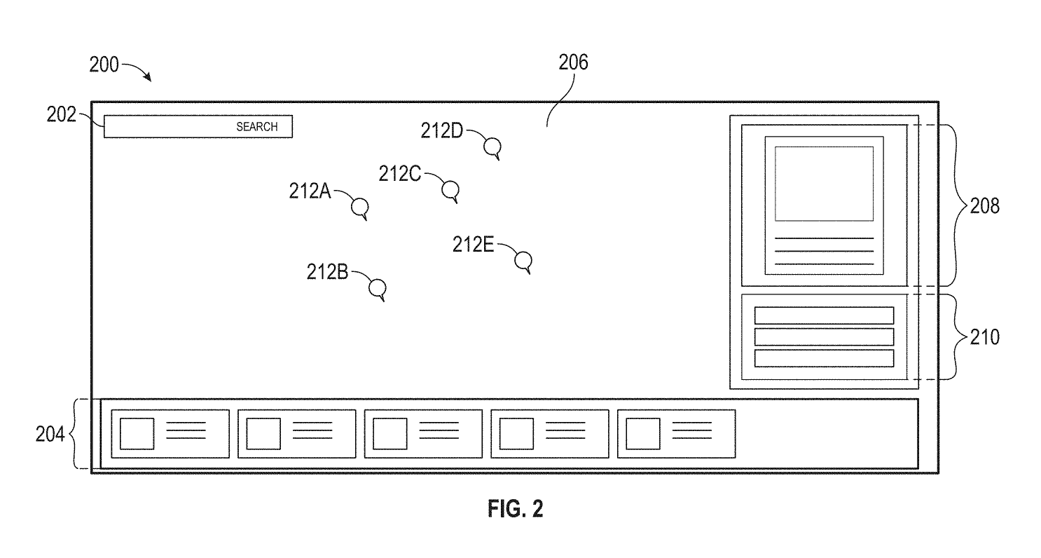

FIG. 2 shows an example floor plan for a graphical user interface (GUI) 200 that may be utilized in an application to manage objects in the IoT. The GUI 200 may comprise a search region 202 for a search input and configuration from a user. For example, the search region 202 may be used for finding single and multiple objects in a particular geolocation. The search region 202 may further allow for filter options to specify different filters for a search (e.g., based on attributes or properties for a particular object). In one example, the search region 202 allows a user to search for all objects (e.g., machines, street lights, maintenance person or crew, etc.) in a particular geolocation. The results of the search would be displayed in the map region 206. In another example, the search region 202 allows a user to specify that the map region 206 only display a subset of the objects in a particular geolocation. For instance, a user may only want to see the objects that are not functioning properly (e.g., broken street lights, malfunctioning machines, etc.) in the particular geolocation.

The map region 206 may display a map with one or more objects 212A-E as a result of the search input from the user. The GUI 200 may further comprise a preview region 204 to preview objects displayed in a map view. For example, the preview region 204 may comprise further details for each of the objects shown in the map region 206.

The GUI 200 may further comprise a single preview region 208 where a single object that has been selected by a user may be previewed. For example, the single preview region 208 may comprise further details for the selected object in the map region 206.

The GUI 200 may further comprise a collection region 210. The collection region 210 may display relevant objects that have been selected by a user. For example, a user may select, drag and drop one or more objects from the map region 206 into the collection region 210. In another example, a user may draw a fence around one or more objects and drag the selected objects in the fence from the map region 206 to the collection region 210. In another example, a user may select multiple objects by holding a particular key, mouse button, long press with a finger or pointing device, to select multiple objects to drag and drop into the collection region 210.

The collection region 210 may be for objects for which a user would like to perform particular actions. For example, a user may want to view various machinery in a particular geolocation. The user may then want to compare two or more of the machines that are not working to determine if there is a common problem among the machines, the different characteristics of the machines, etc. In another example, the user may want to create a work order for maintenance of the machines.

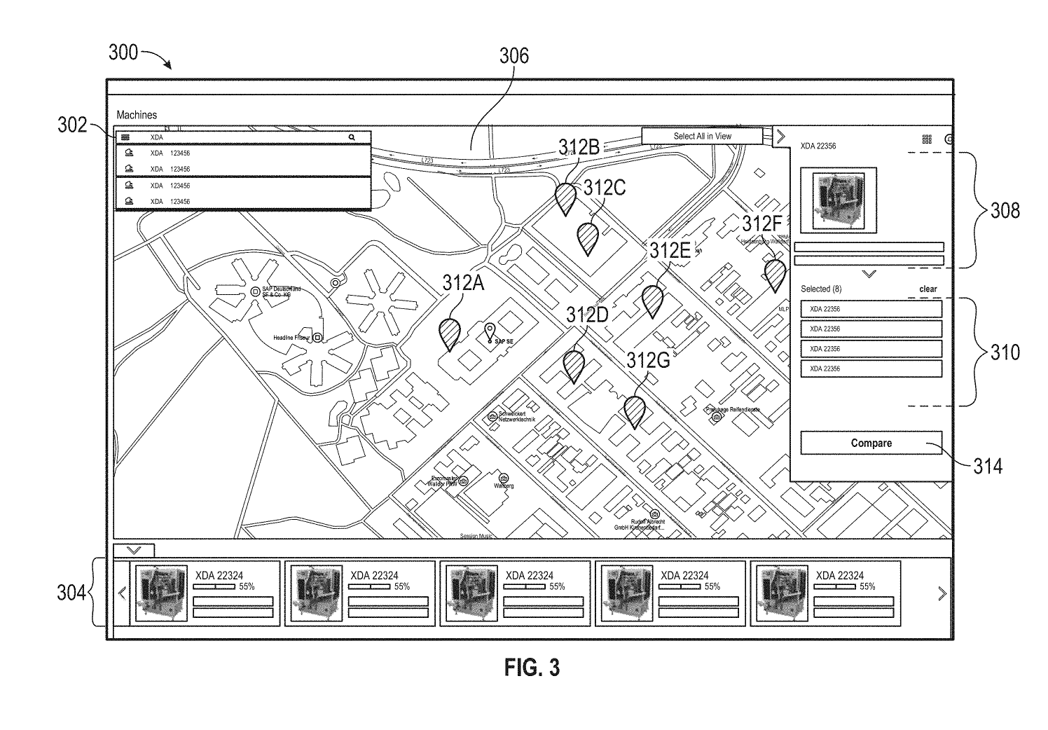

FIG. 3 shows an example GUI 300 illustrating results of a search for machines in a specified geolocation. The GUI 300 comprises a search region 302 to search for particular machines (e.g., by name, model number, unique identifier, etc.), a preview region 304 to preview machines (e.g., machines 312A-G) displayed in the map region 306, a single preview region 308 that may comprise further details for the selected machine in the map region 306, and a collection region 310 to display machines that have been selected by the user (e.g., dragged and dropped, etc., as explained above). The action region 314 may allow a user to perform a particular action, such as a compare action to compare selected machines. The single preview region 308 and preview region 304 may be maximized (as shown here) or minimized so that the user may view more of the map region 306.

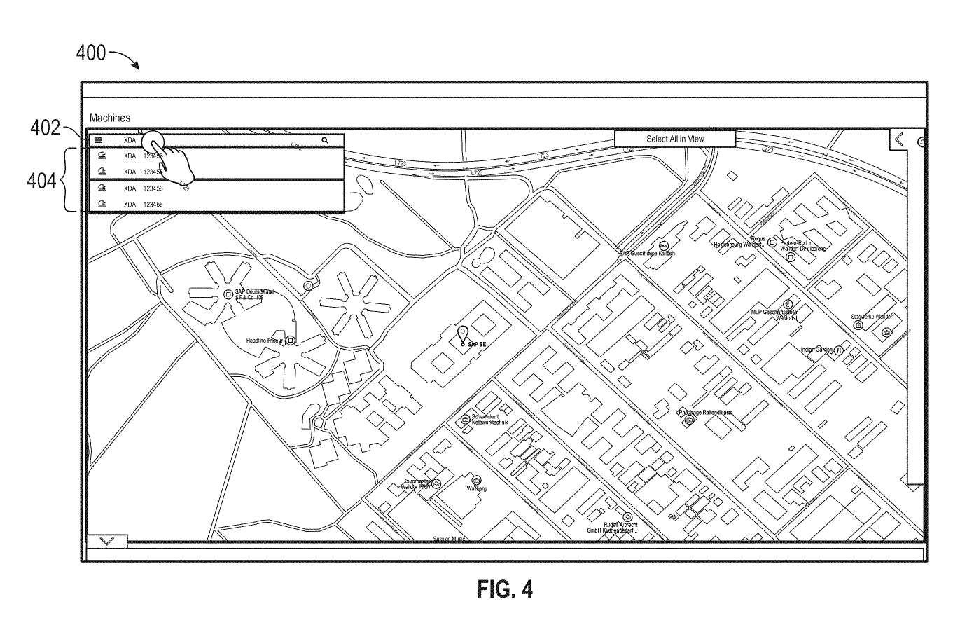

To search for a particular object (e.g., an apparatus such as a machine, street light, device, etc.), a user may input search terms into a search region 402 as shown in the GUI 400 of FIG. 4 that is displayed on a device (e.g., client device 110). When the user starts typing in the search terms, a list of suggested items 404 may be displayed below the input of the search terms. For example, once a user starts typing in search terms, the characters input in the search region 402 are sent from the client device 110 to a server computer (e.g., API server 120 of server system 102 or third party server 130) and the server computer may access one or more databases of objects to determine a list of relevant search terms to return to the client device 110 to be displayed as the list of suggested items 404. Once the user has finished entering the search term, or selects a search term from the list of suggested items 404, a request for information related to objects associated with the search term is sent from the client device 110 to the server computer (e.g., API server 120 of server system 102 or third party server 130). The request for information may comprise the search terms and a specified geolocation.

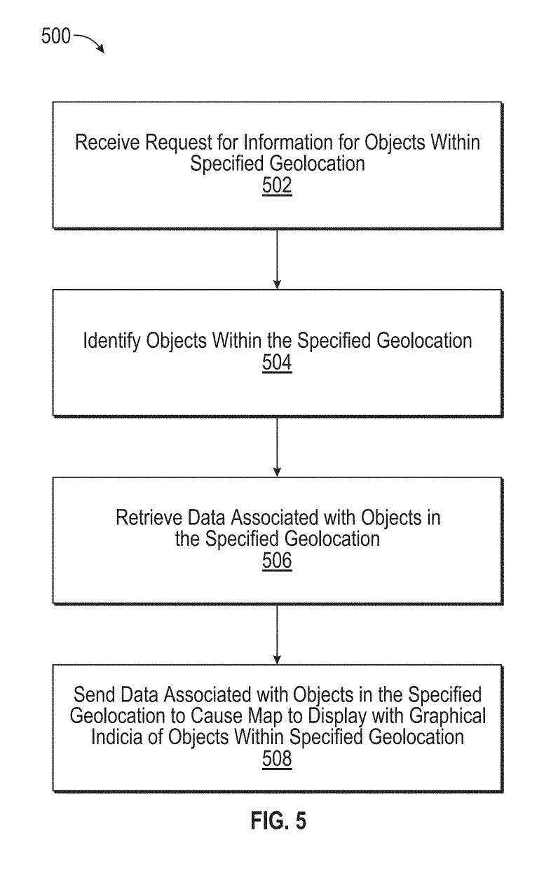

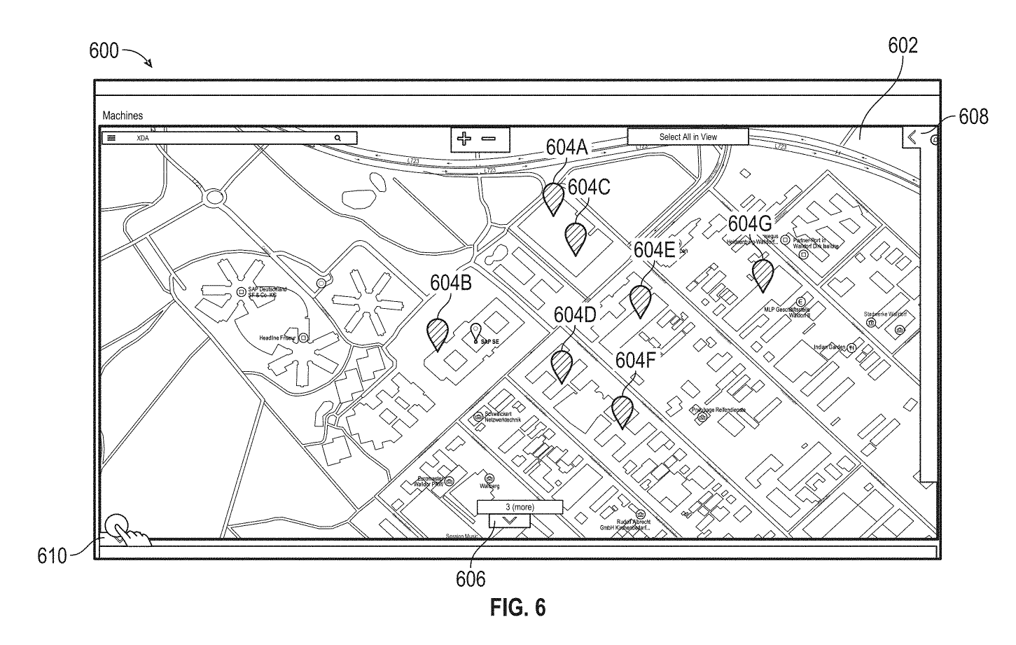

FIG. 5 is a flow chart illustrating aspects of a method 500, according to some example embodiments, for receiving a request for information for objects within a specified geolocation. For illustrative purposes, method 500 is described with respect to the networked system 100 of FIG. 1 and example GUIs of FIGS. 6-7, 8A-D, and 9-10. It is to be understood that method 500 may be practiced with other system configurations in other embodiments.

In operation 502, a server computer API server 120 or third party server 130) receives the request for information for objects within a specified geolocation, from the client device 110. As explained above, the request may comprise search terms and a specified geolocation.

At operation 504 the server computer (e.g., IoT object management server 124 or third party server 130) identifies objects within the specified geolocation. For example, the server computer may access one or more databases 126 to look up objects that are within the specified geolocation. The one or more databases 126 may store objects and data associated with the objects including a geolocation associated with each of the objects. The server computer may search the one or more databases for objects that are associated with the search terms and that have a geolocation within the specified geolocation to identify objects within the specified geolocation.

In operation 506, the server computer may retrieve, from the one or more databases 126, data associated with the objects within the specified geolocation. The data may comprise names of the objects, unique identifiers for the objects, model numbers, status of the objects, images related to the objects, descriptions of the objects, manufacturer information for the objects, release information (e.g., date, version, etc.), expiration dates, service dates, geolocation, and so forth.

The server computer may send the data associated with the objects within the specified geolocation to cause a map to display with graphical indicia of objects within the specified geolocation, as shown in operation 508. For example, the server computer may return the data to the client device 110 and the client device 110 may display a GUI (e.g., via client application 114) with a map of the specified geolocation and a graphical indicium at the geolocation for each of the objects in the specified geolocation.

FIG. 6 shows an example GUI 600 displaying a map 602 with graphical indicia 604A-G for each of the objects in the specified geolocation. In FIG. 6 the indicia 604A-G are shown as pins. In other examples, the indicia may include data related to each of the objects (e.g., status for each object, object name, etc.). The GUI may have an indicator 606 to show that more results are shown below on the map 602 (e.g., three more objects are below the area shown in the map 602). A user may select the indicator 606 to navigate to the area to show the additional objects. The GUI 600 also shows a single preview region 608 for viewing a selected object and preview region 610 for displaying a preview of the objects currently displayed on the map 602, in minimized form.

In one example, the indicia may indicate a status of the object. The status of the object may be regularly updated. For example, the server computer may access a database (e.g., one or more databases 126) to periodically (e.g., ever 5 seconds, 10 second, 1 minute, 5 minutes, etc.) check for any updated status information for the objects displayed on the map. In another example, the status of each object displayed on the map of the specified geolocation may be regularly updated by receiving updated status information when the status information has changed.

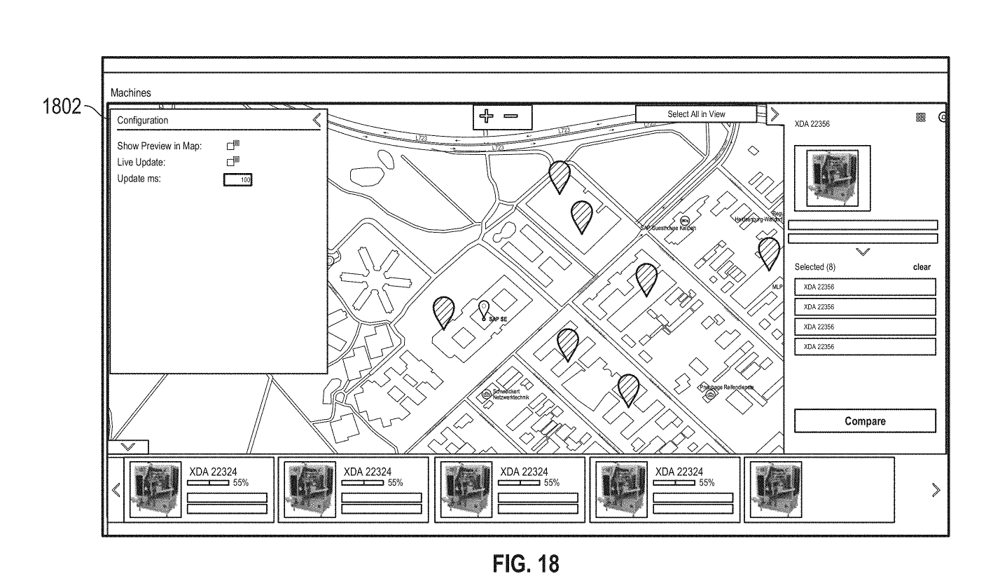

FIG. 18 shows an example of a configuration panel 1802 where a user may configure the setting to include live status updates. The configuration panel 1802 may comprise an option to show a preview in the map, an option to receive live updates on the status of objects, and a setting to allow the user to set how often the status of the objects or information related to the objects is updated (e.g., every 10 seconds, every 1 minute, every hour, etc.).

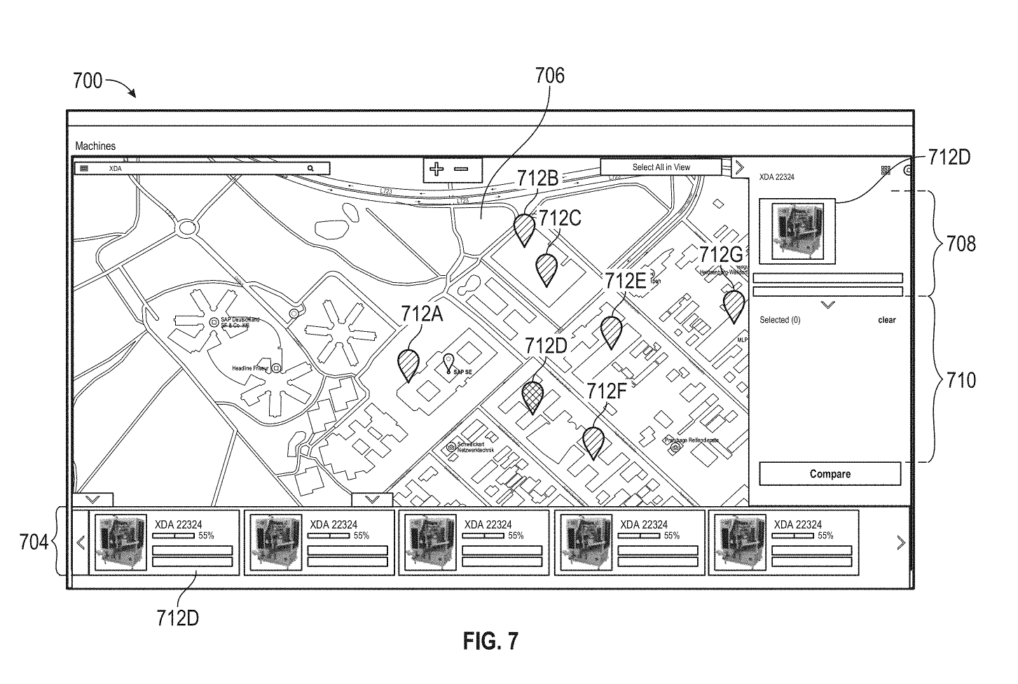

FIG. 7 shows a GUI 700 with a single preview region 708, a collection region 710, and a preview region 704 in maximized form. The preview region 704 shows a preview of objects 712A-G that are displayed in the map region 706. A user may select an object to preview it. For example, a user may select object 712D in the map region 706 or in the preview region 704. The client device 110 (e.g., via client application 114) may detect that a user has selected the object 712D and cause the object 712D to display in the single preview region 708. In addition, the selected object 712D may be highlighted in the preview region 704.

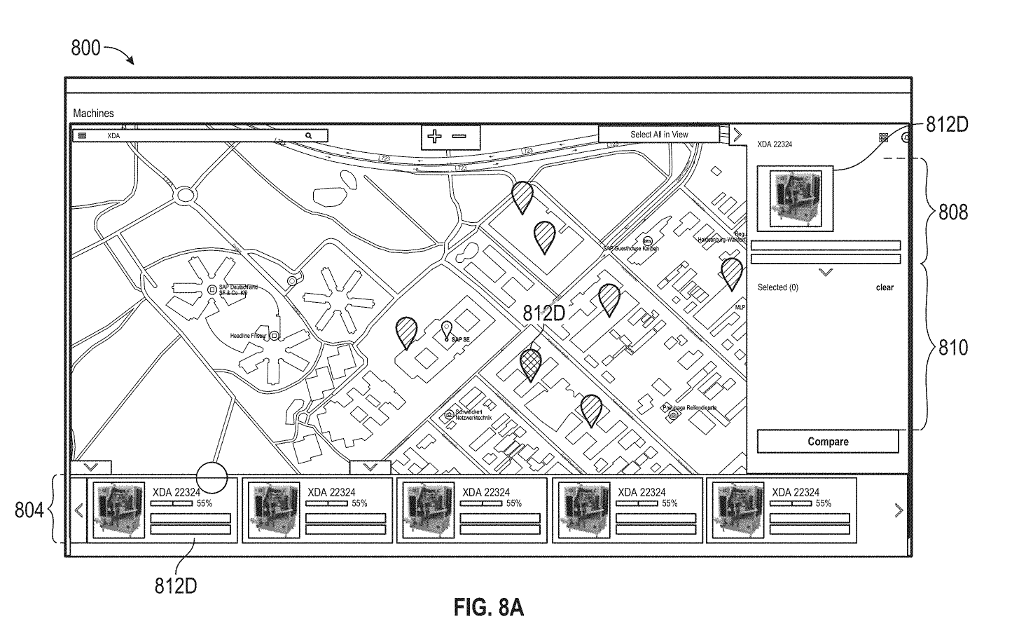

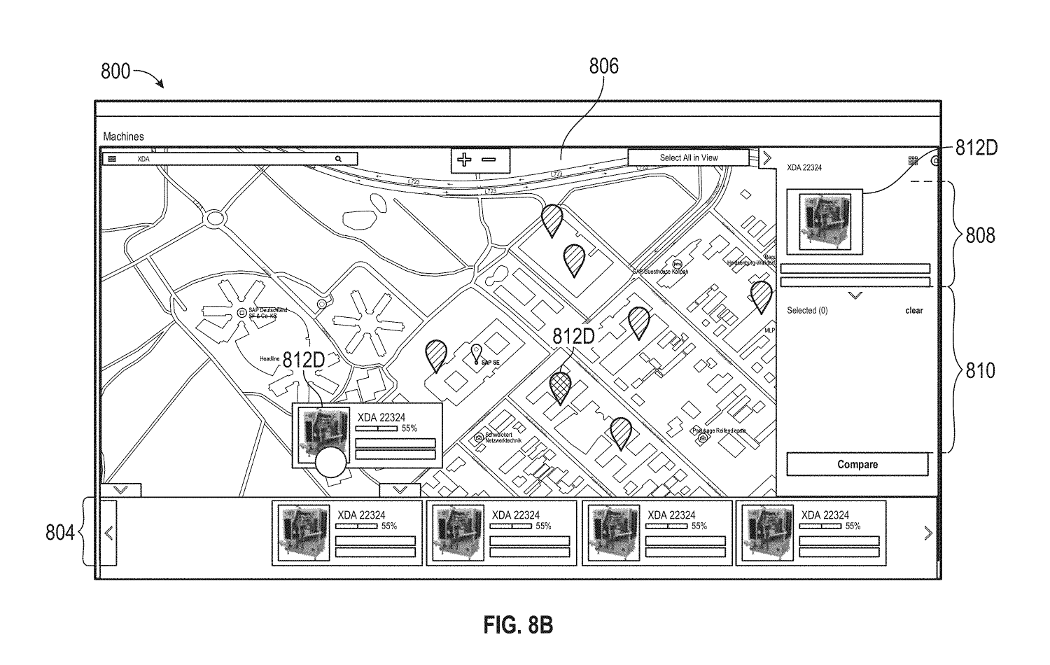

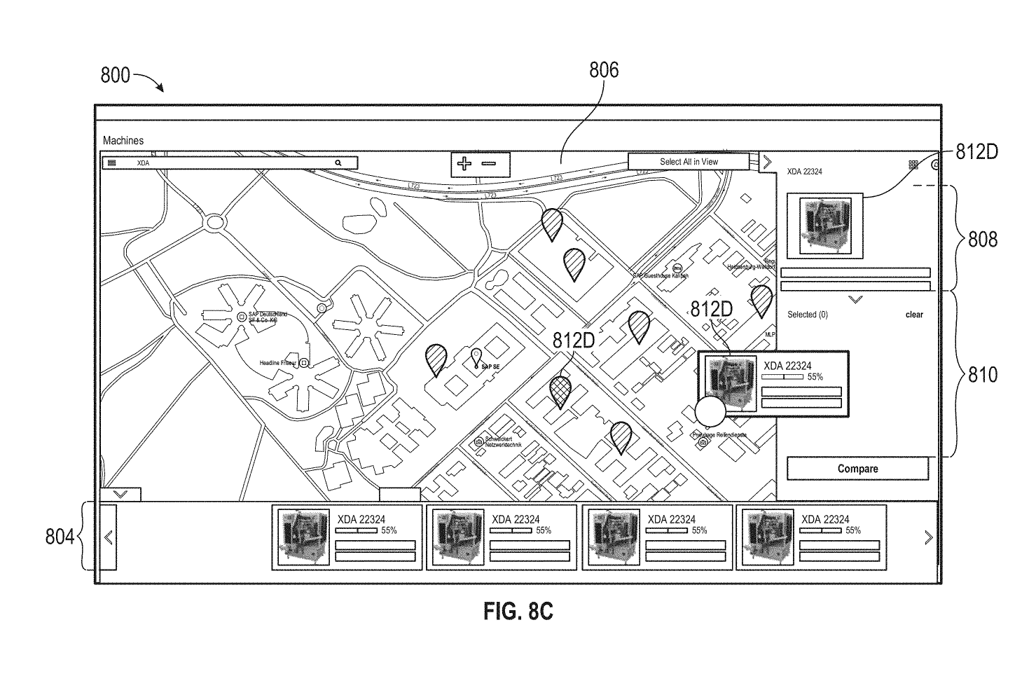

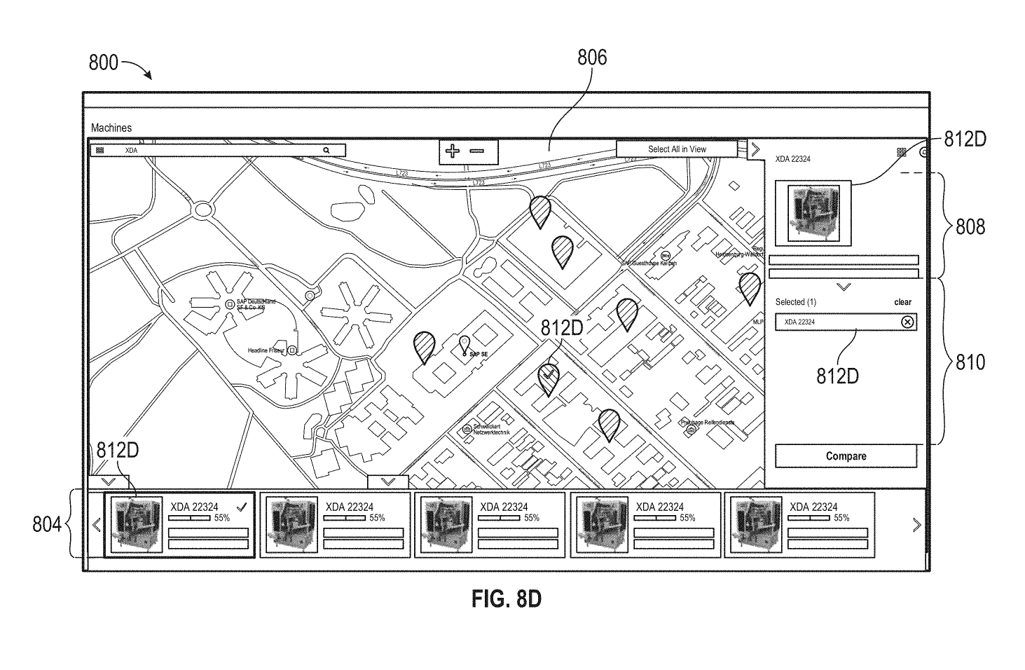

A user may select one or more objects to be added to a collection region of a GUI. FIGS. 8A-8C show an example of how a user may select an object 812D from a preview region 804 and drag and drop the object 812D into a collection region 810 to add the object 812D to the collection region 810. FIG. 8D shows the object 812D added to the collection region 810. The indicia for the object 812D that is shown in map region 806 may also change to indicate that the object 812D has been added to the collection region 810. An additional or alternative way for a user to add one or more objects to a collection region may be to select one or more indicia for objects on the map region and then drag and drop the indicium into the collection region to add them to the collection region.

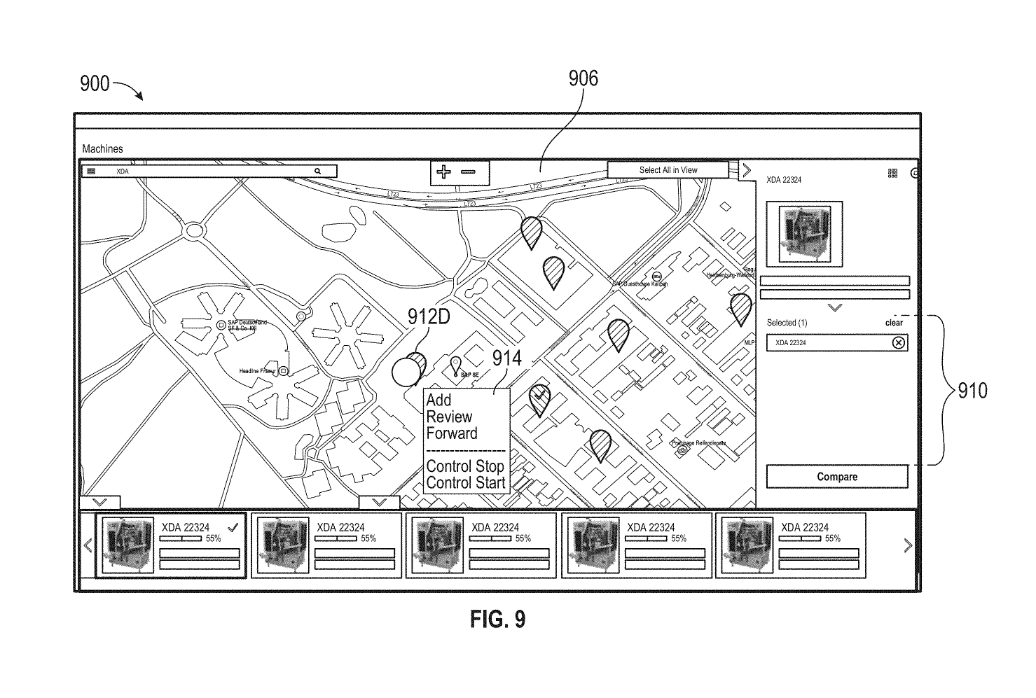

FIG. 9 shows yet another way for a user to add one or more objects to a collection region 910. In this example, a user may select an object 912D, and in response to selecting the object 912D, additional options 914 may be displayed (e.g., alongside the object in the map 906). One example of additional options may be an “add” option to add the selected object 912D to the collection region 910. Another option may be a “review” option to review further details about the selected object 912D. Another option may be a “forward” option to forward the object 912D to another user or application. In an example where the object 912D is an apparatus, such as a machine, street light, device, or other apparatus, there may be options to stop or start the object 912D (e.g., turn the apparatus on or off, reset the device, etc.

Once a user has added one or more objects to a collection region in a GUI, the user may request an action be performed on the one or more objects in the collection region. Some example actions may include comparing the selected objects, assigning repair for the selected objects, creating an optimal route for maintenance of the selected objects, creating a work order for the selected objects, monitoring the selected objects, shutting off the selected objects, and turning on the selected objects.

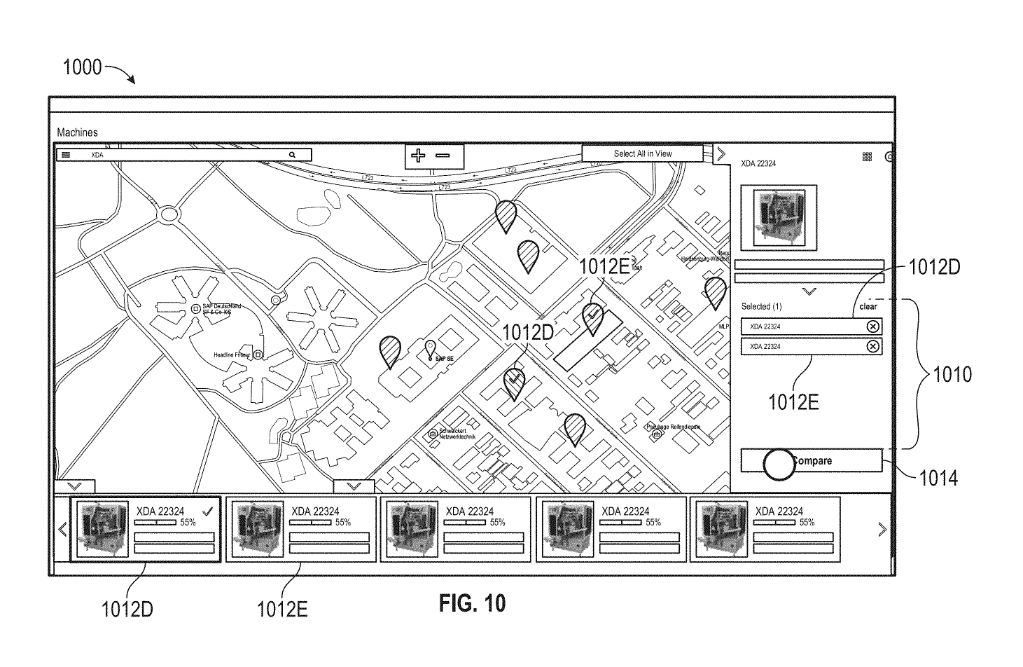

FIG. 10 shows a GUI 1000 with objects 1012D and 1012E that have been added to collection region 1010. In the example in FIG. 10, a user has the option to request an action 1014 to compare the selected objects 1012D and 1012E that have been added to collection region 1010. The user may select the action 1014 to compare the selected objects. The client device 110 may then send the request to perform the action 1014 on the selection of objects to a server computer for processing. The request may comprise the requested action 1014 and the selection of the apparatuses (e.g., a unique identifier associated with each of the apparatuses or other identifying characteristics).

FIG. 11 is a flow chart illustrating aspects of a method 1100, according to some example embodiments, for receiving and processing a request to perform an action on a selection of objects. For illustrative purposes, method 1100 is described with respect to the networked system 100 of FIG. 1 and example GUIs of FIGS. 10 and 12-17. It is to be understood that method 1100 may be practiced with other system configurations in other embodiments.

In operation 1102, a server computer (e.g., API server 120 or third party server 130) receives a request to perform an action on a selection of apparatuses in a specified geolocation. The request may comprise the requested action and the selection of apparatuses in the map of the specified geolocation. In operation 1104, the server computer performs operations according to the requested action. In operation 1106, the server computer provides results of the operations performed according to the requested action. For example, the server computer may send the results to the client device 110 for display on a GUI of the client device 110. The client device 110 may receive the results from the server computer, and cause the results to be displayed in the GUI (e.g., via client application 114).

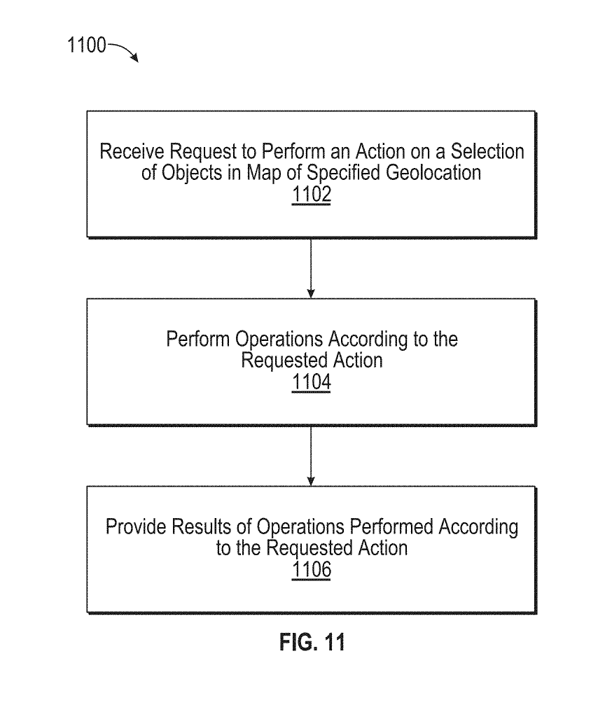

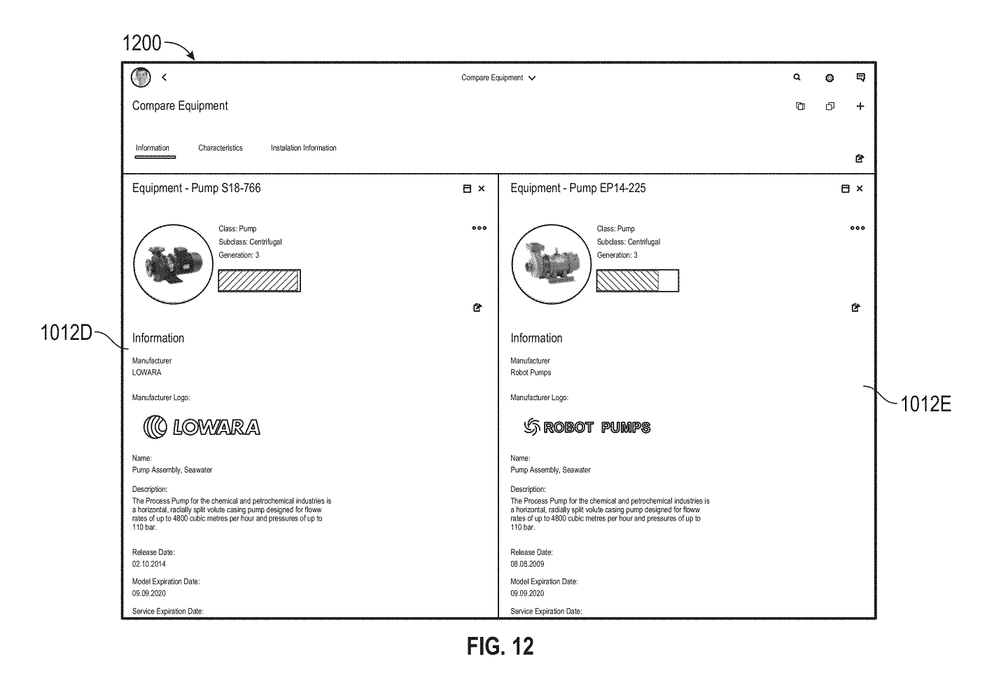

In one example, the action is to compare the apparatuses of the selection of apparatuses, as shown in FIG. 10. To perform the action, the server computer may retrieve properties for each apparatus of the selected subset of apparatuses. For example, each apparatus may be associated with a unique identifier. The server computer may access one or more databases 126 to look up each unique identifier for each apparatus and retrieve data for each apparatus. The server computer may provide the data or properties of each of the apparatuses to be displayed in a GUI of the client device 110. For example, the client device 110 may receive the properties for each of the apparatuses and cause them to be displayed in the GUI 1200, as shown in FIG. 12. The properties displayed may include a name of the object, an image of the object, a status bar of the object, and so forth, as shown in the example in FIG. 12.

In another example, the action is to generate a route for maintenance of the selection of apparatuses. To perform the action, the server computer may determine one or more routes for maintenance or repair of the selection of apparatuses. The server computer may generate the optimal route from the one or more routes and cause them to be displayed on a GUI of a client device 110. For example, the server computer may provide the optimal route to the client device 110. The client device 110 may receive the optimal route and display the optimal route on a map region of the GUI.

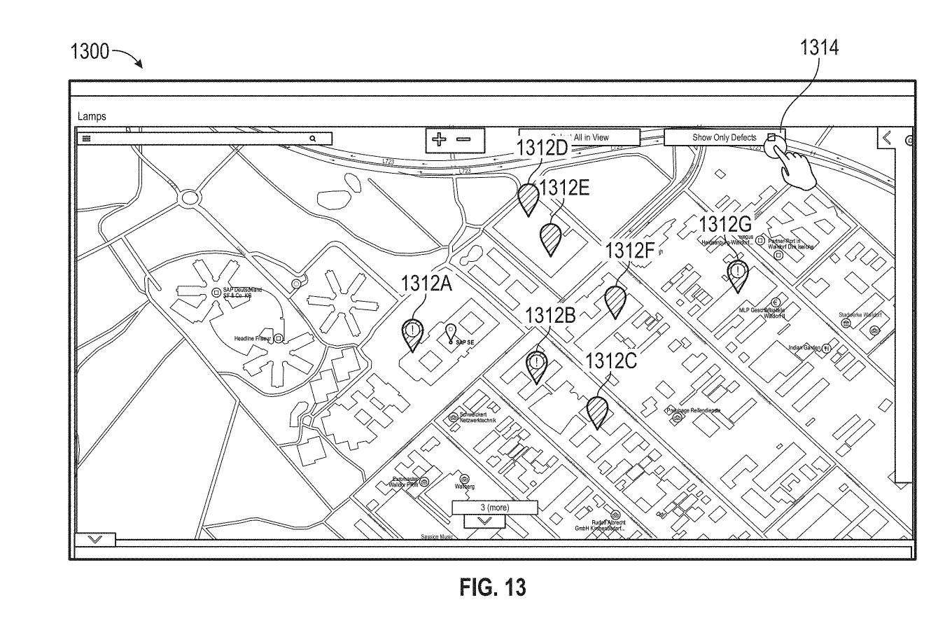

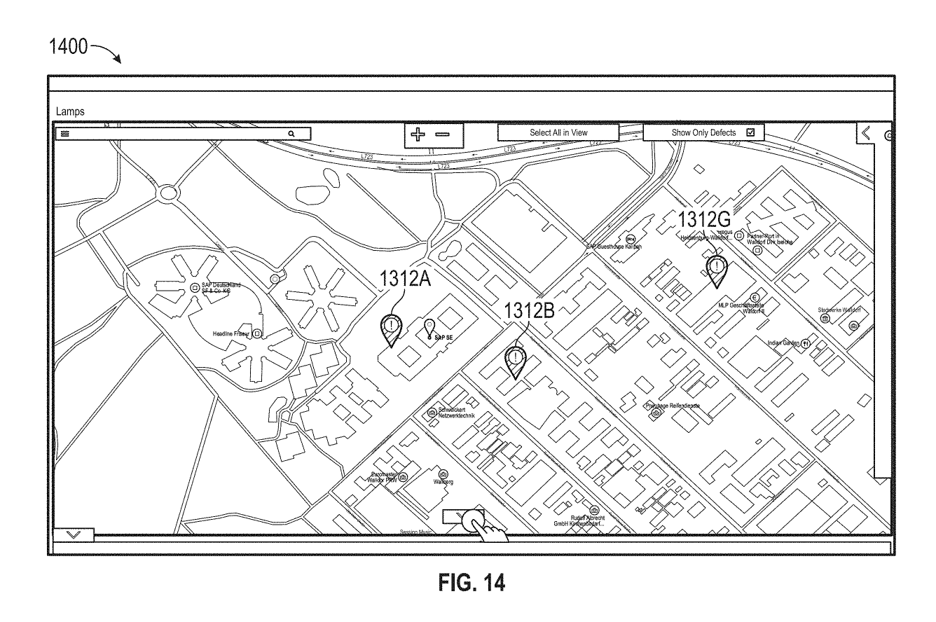

Using street light maintenance as a specific example, a user may want to search for all the objects (e.g., street lights) in a specified geolocation. The street lights 1312A-1312G located in the specified geolocation may be displayed on a GUI 1300 as shown in FIG. 13. The street lights that may have a particular issue or defect may be shown with an indication to illustrate that there is an issue or alert associated with the street light. For example, street lights 1312A, 1312B, and 1312G all indicate that there is an alert or issue associated with these street lights. The GUI 1300 may include an option 1314 for a user to select to view only the objects with issues or defects. FIG. 14 shows an example GUI 1400 with only objects with defects shown (e.g., street lights 1312A, 1312B, and 1312G).

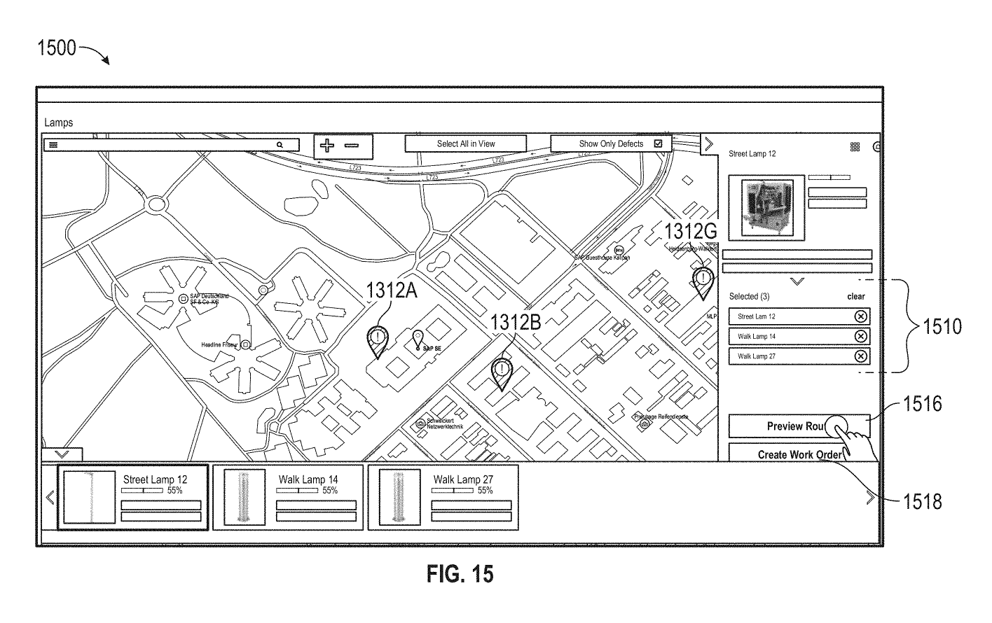

The user may select one or more street lights and request an action be performed on the selected street lights. As shown in the example in FIG. 15, the user may select all of the street lights with defects (e.g., street lights 1312A, 1312B, and 1312G) and add them to a collection region 1510. The GUI 1500 may display one or more actions that the user may request to be performed on the selected street lights. One example action may be to preview route 1516 and another example action may be Create Work Order 1518.

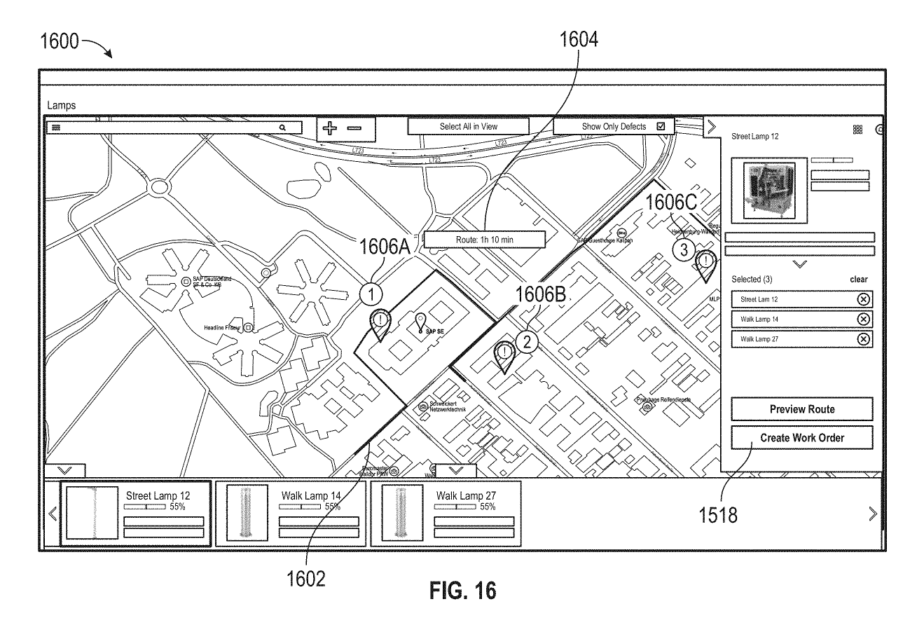

In one example, the user may select to preview route 1516. The client device 110 may receive an indication that the user wishes to request this action, and may send the request to perform the action to the server computer. The server computer may receive the request, as explained above. To perform the action, the server computer may determine one or more routes for maintenance or repair of the selection of apparatuses. The server computer may generate the optimal route from the one or more routes and cause them to be displayed on a GUI of a client device 110. For example, the server computer may provide the optimal route to the client device 110. The client device 110 may receive the optimal route and display the optimal route on a map region of the GUI. FIG. 16 shows an example GUI 1600 showing a route 1602 on a map. The display may indicate an estimated amount of time 1604 to complete the route 1602, and the order (1606A-1606C) in which the objects should be addressed.

In another example, the action is to create a work order for the selection of objects. As described above, a GUI may display one or more actions that the user may request to be performed on the selected street lights. One example action may be to create work order 1518, as shown in FIG. 16. The user may select to create work order 1518. The client device 110 may receive an indication that the user wishes to request this action, and may send the request to perform the action to the server computer. The server computer may receive the request, as explained above. To perform the action, the server computer may generate data to be included in the work order. For example, the work order may comprise a list of the selection of objects and instructions for maintenance of each object of the selection of objects. The server computer may provide the work order to the client device 110. The client device 110 may receive the work order and display the work order in a GUI.

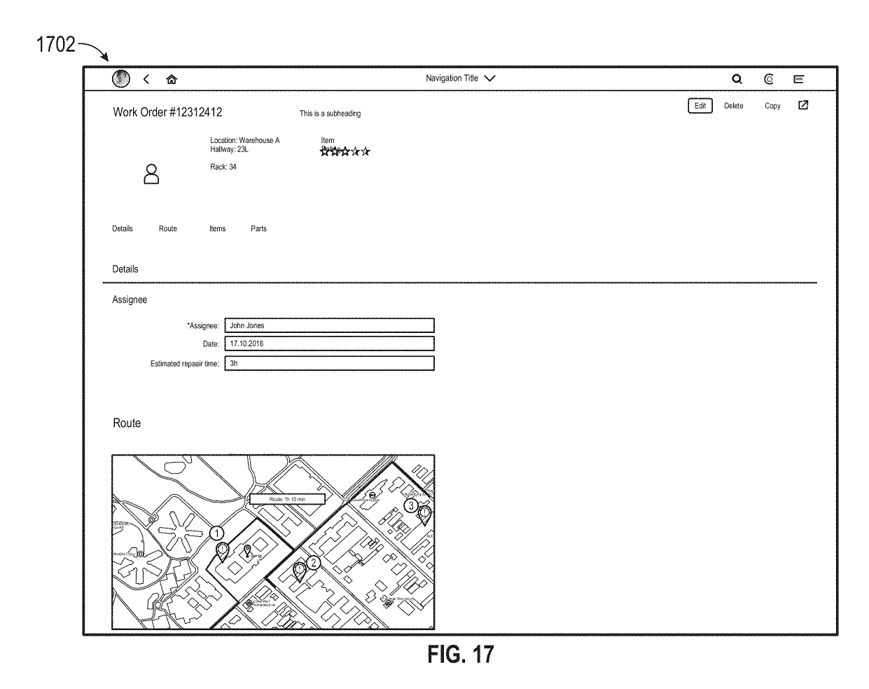

FIG. 17 shows an example work order 1702. The work order 1702 may include a work order number, information about the work order 1702, a list of objects, instructions for maintenance (e.g., routine maintenance instructions, repair instructions, etc.), an order in which to address each object, a map of a route for addressing the objects, a name of a person assigned to the work order 1702, an estimated time to complete the work order 1702, and so forth. Assigning repair or maintenance for the selected object may also be a separate action that may be selected by a user.

In another example, the action is to monitor each object of the selected objects. A user may request this action, the client device 110 may detect and send a request for this action, and the server computer may receive the request, as described above. To perform the action, the server computer may send an updated status for each object of the selection of objects in a regular predetermined time interval and the updated status is displayed on the map of the specified geolocation showing the selection of objects.

In another example, the action is to turn off or turn on one or more of the selected objects. A user may request this action, the client device 110 may detect and send a request for this action, and the server computer may receive the request, as described above. To perform the operation, the server computer may turn on or turn off the one or more objects or cause the one or more objects to be powered on or off. The server computer may sent a response to the client device 110 that the one or more objects have been powered on or off (or whether any objects could not be powered on or off). The client device 110 may update the display to indicate the updated status of the objects (e.g., on, off, alert that objects could not be turned on or off).

The following examples describe various embodiments of methods, machine-readable media, and systems (e.g., machines, devices, or other apparatus) discussed herein.

### Example 1

A computer-implemented method comprising:

receiving, from a computing device, a request for information for apparatuses located within a specified geolocation;

accessing a database to identify apparatuses within the specified geolocation;

retrieving, from the database, data related to the apparatuses within the specified geolocation, the data comprising a geolocation for each of the apparatuses in the specified geolocation and a status for each of the apparatuses;

sending, to the computing device, the data related to the apparatuses within the specified geolocation, causing a graphical indicium of each of the apparatuses in the specified geolocation to be displayed on a map of the specified geolocation, wherein the apparatuses are displayed on the map at the geolocation for each of the apparatuses and wherein the graphical indicium comprises an indication of a status of each of the apparatuses;

receiving, from the computing device, a request to perform an action on a selection of the apparatuses in the map of the specified geolocation, the request comprising the requested action and the selection of the apparatuses in the map of the specified geolocation;

performing operations on the selection of the apparatuses according to the requested action;

providing, to the computing device, results of the operations performed according to the requested action, wherein the results are displayed on a graphical user interface of the computing device.

### Example 2

A method according to Example 1, wherein the requested action is to compare the apparatuses, and wherein performing operations according to the requested action on the selection of the apparatuses comprises:

retrieving properties for each apparatus of the selection of the apparatuses; and

providing the properties of each of the apparatuses to be displayed on the graphical user interface of the computing device.

### Example 3

A method according to any of the previous examples, wherein the requested action is to generate an optimal route for maintenance of the selection of the apparatuses, and wherein performing operations according to the requested action on the selection of the apparatuses comprises:

determining one or more routes for maintenance of the selection of the apparatuses;

determining the most efficient route to generate an optimal route from the one or more routes; and

providing the optimal route to the computing device, wherein the optimal route is displayed on the graphical user interface of the computing device.

### Example 4

A method according to any of the previous examples, wherein the requested action is to create a work order, and wherein performing operations according to the requested action on the selection of the apparatuses comprises:

generating a work order comprising a list of the selection of the apparatuses and instructions for maintenance of each apparatus of the selection of the apparatuses; and

providing the work order to the computing device.

### Example 5

A method according to any of the previous examples, wherein the action is to monitor each apparatus of the selection of the apparatuses, and wherein performing operations according to the requested action on the selection of the apparatuses comprises:

sending an updated status for each apparatus of the selection of the apparatuses in a regular predetermined time interval, wherein the updated status is displayed on the map of the specified geolocation showing the selection of the apparatuses.

### Example 6

A method according to any of the previous examples, wherein the action is to shut off one or more apparatus of the selection of the apparatuses, and wherein performing operations according to the requested action comprises shutting off the one or more apparatus.

### Example 7

A method according to any of the previous examples, wherein the action is to turn on one or more apparatus of the selection of the apparatuses, and wherein performing operations according to the requested action comprises turning on the one or more apparatus.

### Example 8

A method according to any of the previous examples, wherein the status of each of the apparatuses displayed on the map of the specified geolocation is regularly updated.

### Example 9

A method according to any of the previous examples, wherein the status of each of the apparatuses displayed on the map of the specified geolocation is regularly updated by checking a database for any updated status information for the apparatuses displayed on the map.

### Example 10

A method according to any of the previous examples, wherein the status of each of the apparatuses displayed on the map of the specified geolocation is regularly updated by receiving updated status information when the status information has changed.

### Example 11

A server computer comprising:

a processor; and

a computer-readable medium coupled with the processor, the computer-readable medium comprising instructions stored thereon that are executable by the processor to cause the server computer to perform operations comprising:
receiving, from a computing device, a request for information for apparatuses located within a specified geolocation;
accessing a database to identify apparatuses within the specified geolocation;
retrieving, from the database, data related to the apparatuses within the specified geolocation, the data comprising a geolocation for each of the apparatuses in the specified geolocation and a status for each of the apparatuses;
sending, to the computing device, the data related to the apparatuses within the specified geolocation, causing a graphical indicium of each of the apparatuses in the specified geolocation to be displayed on a map of the specified geolocation, wherein the apparatuses are displayed on the map at the geolocation for each of the apparatuses and wherein the graphical indicium comprises an indication of a status of each of the apparatuses;
receiving, from the computing device, a request to perform an action on a selection of the apparatuses in the map of the specified geolocation, the request comprising the requested action and the selection of the apparatuses in the map of the specified geolocation;
performing operations on the selection of the apparatuses according to the requested action;
providing, to the computing device, results of the operations performed according to the requested action, wherein the results are displayed on a graphical user interface of the computing device.

### Example 12

A server computer according to any of the previous examples, wherein the requested action is to compare the apparatuses, and wherein performing operations according to the requested action on the selection of the apparatuses comprises:

retrieving properties for each apparatus of the selection of the apparatuses; and

providing the properties of each of the apparatuses to be displayed on the graphical user interface.

### Example 13

A server computer according to any of the previous examples, wherein the requested action is to generate an optimal route for maintenance of the selection of the apparatuses, and wherein performing operations according to the requested action on the selection of the apparatuses comprises:

determining one or more routes for maintenance of the selection of the apparatuses;

determining the most efficient route to generate an optimal route from the one or more routes; and

providing the optimal route to the computing device, wherein the optimal route is displayed on the graphical user interface of the computing device.

### Example 14

A server computer according to any of the previous examples, wherein the requested action is to create a work order, and wherein performing operations according to the requested action on the selection of the apparatuses comprises:

generating a work order comprising a list of the selection of the apparatuses and instructions for maintenance of each apparatus of the selection of the apparatuses; and

providing the work order to the computing device.

### Example 15

A server computer according to any of the previous examples, wherein the action is to monitor each apparatus of the selection of the apparatuses, and wherein performing operations according to the requested action on the selection of the apparatuses comprises:

sending an updated status for each apparatus of the selection of the apparatuses in a regular predetermined time interval, wherein the updated status is displayed on the map of the specified geolocation showing the selection of the apparatuses.

### Example 16

A server computer according to any of the previous examples, wherein the action is to shut off one or more apparatus of the selection of the apparatuses, and wherein performing operations according to the requested action comprises shutting off the one or more apparatus.

### Example 17

A server computer according to any of the previous examples, wherein the action is to turn on one or more apparatus of the selection of the apparatuses, and wherein performing operations according to the requested action comprises turning on the one or more apparatus.

### Example 18

A server computer according to any of the previous examples, wherein the status of each of the apparatuses displayed on the map of the specified geolocation is regularly updated by checking a database for any updated status information for the apparatuses displayed on the map.

### Example 19

A server computer according to any of the previous examples, wherein the status of each of the apparatuses displayed on the map of the specified geolocation is regularly updated by receiving updated status information when the status information has changed.

### Example 20

A non-transitory computer-readable medium comprising instructions stored thereon that are executable by at least one processor to cause a first computing device to perform operations comprising:

receiving, from a second computing device, a request for information for apparatuses located within a specified geolocation;

accessing a database to identify apparatuses within the specified geolocation;

retrieving, from the database, data related to the apparatuses within the specified geolocation, the data comprising a geolocation for each of the apparatuses in the specified geolocation and a status for each of the apparatuses;

sending, to the second computing device, the data related to the apparatuses within the specified geolocation, causing a graphical indicium of each of the apparatuses in the specified geolocation to be displayed on a map of the specified geolocation, wherein the apparatuses are displayed on the map at the geolocation for each of the apparatuses and wherein the graphical indicium comprises an indication of a status of each of the apparatuses;

receiving, from the second computing device, a request to perform an action on a selection of the apparatuses in the map of the specified geolocation, the request comprising the requested action and the selection of the apparatuses in the map of the specified geolocation;

performing operations on the selection of the apparatuses according to the requested action; and

providing, to the second computing device, results of the operations performed according to the requested action, wherein the results are displayed on a graphical user interface of the second computing device.

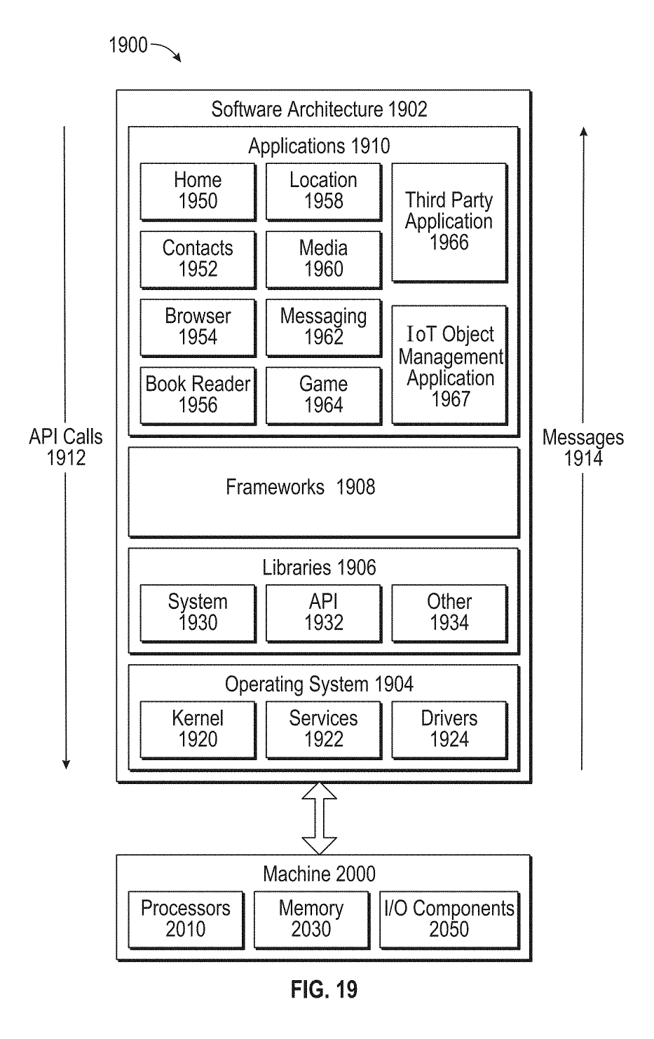

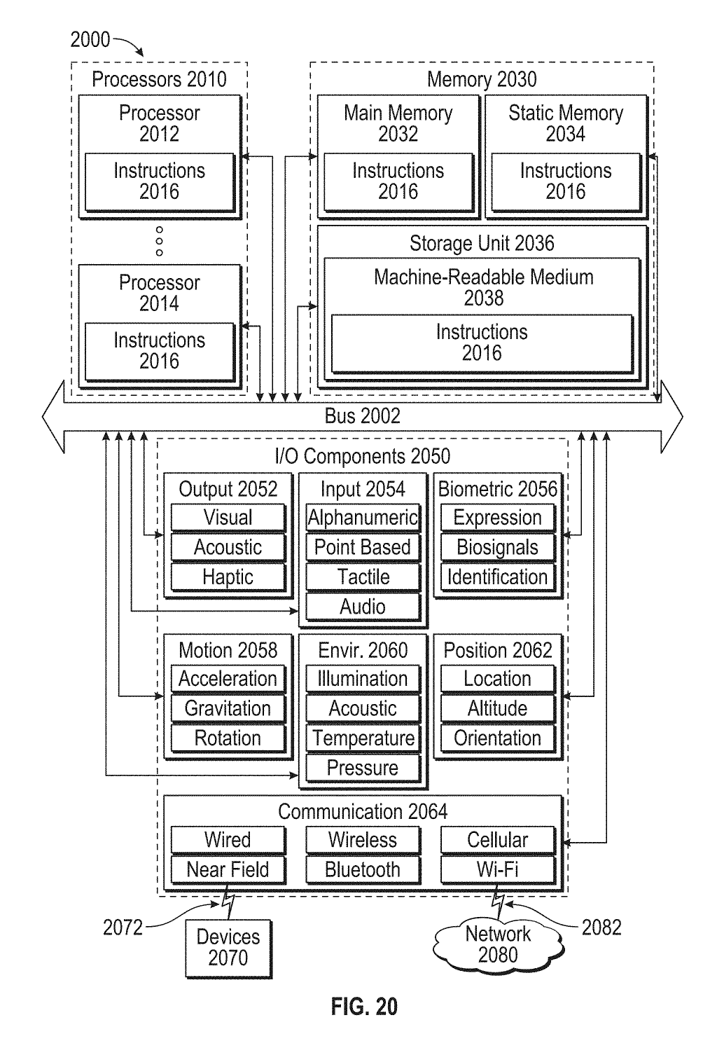

FIG. 19 is a block diagram 1900 illustrating software architecture 1902, which can be installed on any one or more of the devices described above. For example, in various embodiments, client devices 110 and server systems 130, 102, 120, 122, and 124 may be implemented using some or all of the elements of software architecture 1902. FIG. 19 is merely a non-limiting example of a software architecture, and it will be appreciated that many other architectures can be implemented to facilitate the functionality described herein. In various embodiments, the software architecture 1902 is implemented by hardware such as machine 2000 of FIG. 20 that includes processors 2010, memory 2030, and I/O components 2050. In this example, the software architecture 1902 can be conceptualized as a stack of layers where each layer may provide a particular functionality. For example, the software architecture 1902 includes layers such as an operating system 1904, libraries 1906, frameworks 1908, and applications 1910. Operationally, the applications 1910 invoke application programming interface (API) calls 1912. through the software stack and receive messages 1914 in response to the API calls 1912, consistent with some embodiments.

In various implementations, the operating system 1904 manages hardware resources and provides common services. The operating system 1904 includes, for example, a kernel 1920, services 1922, and drivers 1924. The kernel 1920 acts as an abstraction layer between the hardware and the other software layers, consistent with some embodiments. For example, the kernel 1920 provides memory management, processor management (e.g., scheduling), component management, networking, and security settings, among other functionality. The services 1922 can provide other common services for the other software layers. The drivers 1924 are responsible for controlling or interfacing with the underlying hardware, according to some embodiments. For instance, the drivers 1924 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 1906 provide a low-level common infrastructure utilized by the applications 1910. The libraries 1906 can include system libraries 1930 (e.g., C standard library) that can provide functions such as memory allocation functions, string manipulation functions, mathematic functions, and the like. In addition, the libraries 1906 can include API libraries 1932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and in three dimensions (3D) graphic content on a display), database libraries (e.g., SQLite to provide various relational database functions), web libraries (e.g., WebKit to provide web browsing functionality), and the like. The libraries 1906 can also include a wide variety of other libraries 1934 to provide many other APIs to the applications 1910.

The frameworks 1908 provide a high-level common infrastructure that can be utilized by the applications 1910, according to some embodiments. For example, the frameworks 1908 provide various graphic user interface (GUI) functions, high-level resource management, high-level location services, and so forth. The frameworks 1908 can provide a broad spectrum of other APIs that can be utilized by the applications 1910, some of which may be specific to a particular operating system 1904 or platform.

In an example embodiment, the applications 1910 include a home application 1950, a contacts application 1952, a browser application 1954, a book reader application 1956, a location application 1958, a media application 1960, a messaging application 1962, a game application 1964, and a broad assortment of other applications such as a third party applications 1966. According to some embodiments, the applications 1910 are programs that execute functions defined in the programs. Various programming languages can be employed to create one or more of the applications 1910, structured in a variety of manners, such as object-oriented programming languages (e.g., Objective-C, Java, or C++) or procedural programming languages (e.g., C or assembly language). In a specific example, the third party application 1966 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third party application 1966 can invoke the API calls 1912 provided by the operating system 1904 to facilitate functionality described herein.

Some embodiments may particularly include an IoT object management application 1967. In certain embodiments, this may be a stand-alone application that operates to manage communications with a server system such as third party servers 130 or server system 102. In other embodiments, this functionality may be integrated with another application such as a mapping and location application or another such application. IoT object management application 1967 may request and display various data related to objects (e.g., geolocation, status information, images, optimal routes, preview data, etc.) and may provide the capability for a user to input data related to the objects via a touch interface, keyboard, or using a camera device of machine 2000, communication with a server system via I/O components 2050, and receipt and storage of object data in memory 2030. Presentation of object information and user inputs associated with objects and object information may be managed by IoT object management application 1967 using different frameworks 1908, library 1906 elements, or operating system 1904 elements operating on a machine 2000.

FIG. 20 is a block diagram illustrating components of a machine 2000, according to some embodiments, able to read instructions from a machine-readable medium (e.g., a machine-readable storage medium) and perform any one or more of the methodologies discussed herein. Specifically, FIG. 20 shows a diagrammatic representation of the machine 2000 in the example form of a computer system, within which instructions 2016 (e.g., software, a program, an application 1910, an applet, an app, or other executable code) for causing the machine 2000 to perform any one or more of the methodologies discussed herein can be executed. In alternative embodiments, the machine 2000 operates as a standalone device or can be coupled (e.g., networked) to other machines. In a networked deployment, the machine 2000 may operate in the capacity of a server machine 130, 102, 120, 122, 124, etc., or a client device 110 in a server-client network environment, or as a peer machine in a peer-to-peer (or distributed) network environment. The machine 2000 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 2016, sequentially or otherwise, that specify actions to be taken by the machine 2000. Further, while only a single machine 2000 is illustrated, the term “machine” shall also be taken to include a collection of machines 2000 that individually or jointly execute the instructions 2016 to perform any one or more of the methodologies discussed herein.

In various embodiments, the machine 2000 comprises processors 2010, memory 2030, and I/O components 2050, which can be configured to communicate with each other via a bus 2002. In an example embodiment, the processors 2010 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) include, for example, a processor 2012 and a processor 2014 that may execute the instructions 2016. The term “processor” is intended to include multi-core processors 2010 that may comprise two or more independent processors 2012, 2014 (also referred to as “cores”) that can execute instructions 2016 contemporaneously. Although FIG. 20 shows multiple processors 2010, the machine 2000 may include a single processor 2010 with a single core, a single processor 2010 with multiple cores (e.g., a multi-core processor 2010), multiple processors 2012, 2014 with a single core, multiple processors 2012, 2014 with multiples cores, or any combination thereof.

The memory 2030 comprises a main memory 2032, a static memory 2034, and a storage unit 2036 accessible to the processors 2010 via the bus 2002, according to some embodiments. The storage unit 2036 can include a machine-readable medium 2038 on which are stored the instructions 2016 embodying any one or more of the methodologies or functions described herein. The instructions 2016 can also reside, completely or at least partially, within the main memory 2032, within the static memory 2034, within at least one of the processors 2010 (e.g., within the processor's cache memory), or any suitable combination thereof, during execution thereof by the machine 2000. Accordingly, in various embodiments, the main memory 2032, the static memory 2034, and the processors 2010 are considered machine-readable media 2038.

As used herein, the term “memory” refers to a machine-readable medium 2038 able to store data temporarily or permanently and may be taken to include, but not be limited to, random-access memory (RAM), read-only memory (ROM), buffer memory, flash memory, and cache memory. While the machine-readable medium 2038 is shown, in an example embodiment, to be a single medium, the term “machine-readable medium” should be taken to include a single medium or multiple media (e.g., a centralized or distributed database, or associated caches and servers) able to store the instructions 2016. The term “machine-readable medium” shall also be taken to include any medium, or combination of multiple media, that is capable of storing instructions (e.g., instructions 2016) for execution by a machine (e.g., machine 2000), such that the instructions 2016, when executed by one or more processors of the machine 2000 (e.g., processors 2010), cause the machine 2000 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 2050 include a wide variety of components to receive input, provide output, produce output, transmit information, exchange information, capture measurements, and so on. In general, it will be appreciated that the I/O components 2050 can include many other components that are not shown in FIG. 20. The I/O components 2050 are grouped according to functionality merely for simplifying the following discussion, and the grouping is in no way limiting. In various example embodiments, the I/O components 2050 include output components 2052 and input components 2054. The output components 2052 include visual components (e.g., a display such as a plasma display panel (PDP), a light emitting diode (LED) display, a liquid crystal display (LCD), a projector, or a cathode ray tube (CRT), acoustic components (e.g., speakers), haptic components (e.g., a vibratory motor), other signal generators, and so forth. The input components 2054 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further example embodiments, the I/O components 2050 include biometric components 2056, motion components 2058, environmental components 2060, or position components 2062, among a wide array of other components. For example, the biometric components 2056 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 2058 include acceleration sensor components (e.g., accelerometer), gravitation sensor components, rotation sensor components (e.g., gyroscope), and so forth. The environmental components 2060 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 2062 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 2050 may include communication components 2064 operable to couple the machine 2000 to a network 2080 or devices 2070 via a coupling 2082 and a coupling 2072, respectively. For example, the communication components 2064 include a network interface component or another suitable device to interface with the network 2080. In further examples, communication components 2064 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 2070 may be another machine 2000 or any of a wide variety of peripheral devices (e.g., a peripheral device coupled via a Universal Serial Bus (USB)).

Moreover, in some embodiments, the communication components 2064 detect identifiers or include components operable to detect identifiers. For example, the communication components 2064 include radio frequency identification (RFID) tag reader components, NFC smart tag detection components, optical reader components (e.g., an optical sensor to detect a one-dimensional bar codes such as a Universal Product Code (UPC) bar code, multi-dimensional bar codes such as a ick Response (QR) code, Aztec Code, Data Matrix, Dataglyph, MaxiCode PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 2064, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 2080 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a WI-FI® network, another type of network, or a combination of two or more such networks. For example, the network 2080 or a portion of the network 2080 may include a wireless or cellular network, and the coupling 2082 may be a Code Division Multiple Access (CDMA) connection, a Global System for Mobile communications (GSM) connection, or another type of cellular or wireless coupling. In this example, the coupling 2082 can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UNITS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 2016 are transmitted or received over the network 2080 using a transmission medium via a network interface device (e.g., a network interface component included in the communication components 2064) and utilizing any one of a number of well-known transfer protocols (e.g., Hypertext Transfer Protocol (HTTP). Similarly, in other example embodiments, the instructions 2016 are transmitted or received using a transmission medium via the coupling 2072 (e.g., a peer-to-peer coupling) to the devices 2070. The term “transmission medium” shall be taken to include any intangible medium that is capable of storing, encoding, or carrying the instructions 2016 for execution by the machine 2000, and includes digital or analog communications signals or other intangible media to facilitate communication of such software.

Furthermore, the machine-readable medium 2038 is non-transitory (in other words, not having any transitory signals) in that it does not embody a propagating signal. However, labeling the machine-readable medium 2038 “non-transitory” should not be construed to mean that the medium is incapable of movement; the medium 2038 should be considered as being transportable from one physical location to another. Additionally, since the machine-readable medium 2038 is tangible, the medium 2038 may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
receiving, from a computing device, a request for information for apparatuses located within a specified geolocation;
accessing a database to identify apparatuses within the specified geolocation;
retrieving, from the database, data related to the apparatuses within the specified geolocation, the data comprising a geolocation for each of the apparatuses in the specified geolocation and a status for each of the apparatuses;
sending, to the computing device, the data related to the apparatuses within the specified geolocation, causing a graphical indicium of each of the apparatuses in the specified geolocation to be displayed on a map of the specified geolocation, wherein the apparatuses are displayed on the map at the geolocation for each of the apparatuses and wherein the graphical indicium comprises an indication of a status of each of the apparatuses;
receiving, from the computing device, a request to perform an action on a selection of the apparatuses in the map of the specified geolocation, the request comprising the requested action and the selection of the apparatuses in the map of the specified geolocation;
performing operations on the selection of the apparatuses according to the requested action;
providing, to the computing device, results of the operations performed according to the requested action, wherein the results are displayed on a graphical user interface of the computing device.

2. The method of claim 1, wherein the requested action is to compare the apparatuses, and wherein performing operations according to the requested action on the selection of the apparatuses comprises:
retrieving properties for each apparatus of the selection of the apparatuses; and
providing the properties of each of the apparatuses to be displayed on the graphical user interface of the computing device.

3. The method of claim 1, wherein the requested action is to generate an optimal route for maintenance of the selection of the apparatuses, and wherein performing operations according to the requested action on the selection of the apparatuses comprises:
determining one or more routes for maintenance of the selection of the apparatuses;
determining the most efficient route to generate an optimal route from the one or more routes; and
providing the optimal route to the computing device, wherein the optimal route is displayed on the graphical user interface of the computing device.

4. The method of claim 1, wherein the requested action is to create a work order, and wherein performing operations according to the requested action on the selection of the apparatuses comprises:
generating a work order comprising a list of the selection of the apparatuses and instructions for maintenance of each apparatus of the selection of the apparatuses; and
providing the work order to the computing device.

5. The method of claim 1, wherein the action is to monitor each apparatus of the selection of the apparatuses, and wherein performing operations according to the requested action on the selection of the apparatuses comprises:
sending an updated status for each apparatus of the selection of the apparatuses in a regular predetermined time interval, wherein the updated status is displayed on the map of the specified geolocation showing the selection of the apparatuses.

6. The method of claim 1, wherein the action is to shut off one or more apparatus of the selection of the apparatuses, and wherein performing operations according to the requested action comprises shutting off the one or more apparatus.

7. The method of claim 1, wherein the action is to turn on one or more apparatus of the selection of the apparatuses, and wherein performing operations according to the requested action comprises turning on the one or more apparatus.

8. The method of claim 1, wherein the status of each of the apparatuses displayed on the map of the specified geolocation is regularly updated.

9. The method of claim 8, wherein the status of each of the apparatuses displayed on the map of the specified geolocation is regularly updated by checking a database for any updated status information for the apparatuses displayed on the map.

10. The method of claim 8, wherein the status of each of the apparatuses displayed on the map of the specified geolocation is regularly updated by receiving updated status information when the status information has changed.

11. A server computer comprising:
a processor; and
a computer-readable medium coupled with the processor, the computer-readable medium comprising instructions stored thereon that are executable by the processor to cause the server computer to perform operations comprising:
receiving, from a computing device, a request for information for apparatuses located within a specified geolocation;
accessing a database to identify apparatuses within the specified geolocation;
retrieving, from the database, data related to the apparatuses within the specified geolocation, the data comprising a geolocation for each of the apparatuses in the specified geolocation and a status for each of the apparatuses;
sending, to the computing device, the data related to the apparatuses within the specified geolocation, causing a graphical indicium of each of the apparatuses in the specified geolocation to be displayed on a map of the specified geolocation, wherein the apparatuses are displayed on the map at the geolocation for each of the apparatuses and wherein the graphical indicium comprises an indication of a status of each of the apparatuses;
receiving, from the computing device, a request to perform an action on a selection of the apparatuses in the map of the specified geolocation, the request comprising the requested action and the selection of the apparatuses in the map of the specified geolocation;
performing operations on the selection of the apparatuses according to the requested action;
providing, to the computing device, results of the operations performed according to the requested action, wherein the results are displayed on a graphical user interface of the computing device.

12. The server computer of claim 11, wherein the requested action is to compare the apparatuses, and wherein performing operations according to the requested action on the selection of the apparatuses comprises:
retrieving properties for each apparatus of the selection of the apparatuses; and
providing the properties of each of the apparatuses to be displayed on the graphical user interface.

13. The server computer of claim 11, wherein the requested action is to generate an optimal route for maintenance of the selection of the apparatuses, and wherein performing operations according to the requested action on the selection of the apparatuses comprises:
determining one or more routes for maintenance of the selection of the apparatuses;
determining the most efficient route to generate an optimal route from the one or more routes; and
providing the optimal route to the computing device, wherein the optimal route is displayed on the graphical user interface of the computing device.

14. The server computer of claim 11, wherein the requested action is to create a work order, and wherein performing operations according to the requested action on the selection of the apparatuses comprises:
generating a work order comprising a list of the selection of the apparatuses and instructions for maintenance of each apparatus of the selection of the apparatuses; and
providing the work order to the computing device.

15. The server computer of claim 11, wherein the action is to monitor each apparatus of the selection of the apparatuses, and wherein performing operations according to the requested action on the selection of the apparatuses comprises:
sending an updated status for each apparatus of the selection of the apparatuses in a regular predetermined time interval, wherein the updated status is displayed on the map of the specified geolocation showing the selection of the apparatuses.

16. The server computer of claim 11, wherein the action is to shut off one or more apparatus of the selection of the apparatuses, and wherein performing operations according to the requested action comprises shutting off the one or more apparatus.

17. The server computer of claim 11, wherein the action is to turn on one or more apparatus of the selection of the apparatuses, and wherein performing operations according to the requested action comprises turning on the one or more apparatus.

18. The server computer of claim 11, wherein the status of each of the apparatuses displayed on the map of the specified geolocation is regularly updated by checking a database for any updated status information for the apparatuses displayed on the map.

19. The server computer of claim 11, wherein the status of each of the apparatuses displayed on the map of the specified geolocation is regularly updated by receiving updated status information when the status information has changed.

20. A non-transitory computer-readable medium comprising instructions stored thereon that are executable by at least one processor to cause a first computing device to perform operations comprising:
receiving, from a second computing device, a request for information for apparatuses located within a specified geolocation;
accessing a database to identify apparatuses within the specified geolocation;
retrieving, from the database, data related to the apparatuses within the specified geolocation, the data comprising a geolocation for each of the apparatuses in the specified geolocation and a status for each of the apparatuses;
sending, to the second computing device, the data related to the apparatuses within the specified geolocation, causing a graphical indicium of each of the apparatuses in the specified geolocation to be displayed on a map of the specified geolocation, wherein the apparatuses are displayed on the map at the geolocation for each of the apparatuses and wherein the graphical indicium comprises an indication of a status of each of the apparatuses;
receiving, from the second computing device, a request to perform an action on a selection of the apparatuses in the map of the specified geolocation, the request comprising the requested action and the selection of the apparatuses in the map of the specified geolocation;
performing operations on the selection of the apparatuses according to the requested action; and
providing, to the second computing device, results of the operations performed according to the requested action, wherein the results are displayed on a graphical user interface of the second computing device.
